(19) United States
(12) Patent Application Publication
(10) Pub. No.: US 2002/0075541 A1
(43) Pub. Date: Jun. 20, 2002

(54) System, device, and method for producing optical data streams in an optical communication network

(76) Inventor: Bruce A. Schofield, Tyngsboro, MA (US)

Correspondence Address: Jeffrey T. Klayman, BROMBERG & SUNSTEIN LLP, 125 Summer Street, Boston, MA, 02110, US

(21) Appl. No.: 09/740,705

(22) Filed: Dec. 19, 2000

(51) Int. Cl. G02B 6/06; H04J 14/02

(52) U.S. Cl. 359/128; 385/118

(57) ABSTRACT

A system, device, and method for producing optical data streams in an optical communication network uses M fixed wavelength lasers and N external modulators (N<M). The M fixed wavelength lasers are coupled to the N external modulators through a photonic cross-connect switch that is capable of routing the outputs of any N of the M fixed wavelength lasers to the N external modulators. The photonic cross-connect switch is configured to route N optical carriers at N specific wavelengths to the N external modulators. N data signals are fed to the N external modulators for producing N optical data streams at the N specific wavelengths. The photonic cross-connect switch maintains the polarity of the N optical carriers that are routed to the N external modulators.

### FIELD OF THE INVENTION

The present invention relates generally to optical networking, and more particularly to producing optical data streams in an optical communication network.

### BACKGROUND OF THE INVENTION

An optical data stream is typically produced by modulating an optical carrier. A laser generates an optical carrier at a predetermined wavelength, and an external modulator coupled to the laser output modulates the optical carrier according to a data signal applied to the external modulator. The resulting optical data stream can be carried over the optical communication network.

There are generally two types of lasers, namely fixed wavelength lasers and tunable lasers. A fixed wavelength laser is capable of generating an optical carrier at a single wavelength. A tunable laser is capable of generating an optical carrier at any of a number of wavelengths. Tunable lasers are generally more flexible than fixed wavelength lasers, but cost substantially more than fixed wavelength lasers.

In an optical communication network that supports M wavelengths, it is sometimes necessary or desirable to produce N optical data streams at N specific wavelengths (where N is less than M).

One way to accomplish this is to use N tunable lasers coupled to N external modulators. Each of the N tunable lasers is tuned to one of the N specific wavelengths, and each of N data sources is fed into one of the N external modulators. This produces N optical data streams at the N specific wavelengths. An advantage of this solution is that it uses a relatively small amount of equipment. A disadvantage of this solution, however, is that it is expensive due to the use of tunable lasers.

Another way to accomplish this is to use M fixed wavelength lasers coupled to M external modulators. The N data signals are fed into those N external modulators that are associated with the N fixed wavelength lasers having the N specific wavelengths, for example, using a cross-connect switch. This produces N optical data streams at the N specific wavelengths. An advantage of this solution is that it is relatively inexpensive compared to the tunable laser solution. A disadvantage of this solution, however, is that is uses a relatively large amount of equipment.

### SUMMARY OF THE INVENTION

In accordance with one aspect of the invention, M fixed wavelength lasers and N external modulators (N<M) are used to produce N optical data streams. The M fixed wavelength lasers are coupled to the N external modulators through a photonic cross-connect switch that is capable of routing the outputs of any N of the M fixed wavelength lasers to the N external modulators. The photonic cross-connect switch is configured to route N optical carriers at N specific wavelengths to the N external modulators. N data signals are fed to the N external modulators for producing N optical data streams at the N specific wavelengths. The photonic cross-connect switch maintains the polarity of the N optical carriers that are routed to the N external modulators.

In accordance with another aspect of the invention, a photonic cross-connect switch includes polarization maintaining means for maintaining the polarity of optical carriers routed from any N of M optical inputs to N optical outputs. In a typical embodiment, polarization maintaining fibers are used for coupling M optical inputs to a photonic cross-connect fabric and for coupling N optical outputs to the photonic cross-connect fabric.

### BRIEF DESCRIPTION OF THE DRAWINGS

The foregoing and other objects and advantages of the invention will be appreciated more fully from the following further description thereof with reference to the accompanying drawings wherein:

FIG. 1 is a system diagram showing an exemplary optical communication system in which N tunable lasers and N external modulators are used to produce N optical data streams at N specific wavelengths, as is known in the art;

FIG. 2 is a system diagram showing an exemplary optical communication system in which M fixed wavelength lasers and M external modulators are used to produce N optical data streams at N specific wavelengths, as is known in the art;

FIG. 3 is a system diagram showing an exemplary optical communication system in which M fixed wavelength lasers and N external modulators are used in conjunction with a MEMS (Micro Electro Mechanical System) to produce N optical data streams at N specific wavelengths, in accordance with an embodiment of the present invention;

FIG. 4 is a block diagram showing the relevant logic blocks of the MEMS in accordance with an embodiment of the present invention; and

FIG. 5 is a system diagram showing an exemplary communication system for producing four optical data streams at any four of sixteen wavelengths, in accordance with an embodiment of the present invention.

### DETAILED DESCRIPTION OF A PREFERRED EMBODIMENT

As discussed above, in an optical communication network that supports M wavelengths, it is sometimes necessary or desirable to produce N optical data streams at N specific wavelengths (where N is less than M). An embodiment of the present invention uses M fixed wavelength lasers and N external modulators to produce the N optical data streams. The M fixed wavelength lasers are coupled to the N external modulators through a photonic cross-connect switch. The photonic cross-connect switch includes at least M optical inputs that are coupled to the outputs of the M fixed wavelength lasers, and also includes at least N optical outputs that are coupled to the inputs of the N external modulators. Within the photonic cross-connect switch, the M optical inputs are coupled to the N optical outputs through a photonic cross-connect fabric that is capable of routing any N of the M optical inputs to the N optical outputs. The photonic cross-connect fabric may be based upon Micro Electro Mechanical System (MEMS) technology, Micro Opto Electro Mechanical System (MOEMS) technology, bubble (champagne) technology, lithium niobate technology, liquid crystal technology, or other photonic switching technology. Optical connections within the photonic cross-connect switch (e.g., from the M optical inputs to the photonic cross-connect fabric and from the photonic cross-connect fabric to the N optical outputs) preferably use polarization maintaining (PM) fiber in order to maintain the polarity of the optical carriers from input to output. In order to produce N optical data streams at N specific wavelengths, the photonic cross-connect switch is configured to route those N optical inputs having the N specific wavelengths to the N optical outputs. The N data signals are fed into the N external modulators. This produces N optical data streams at the N specific wavelengths using M fixed wavelength lasers and N external modulators.

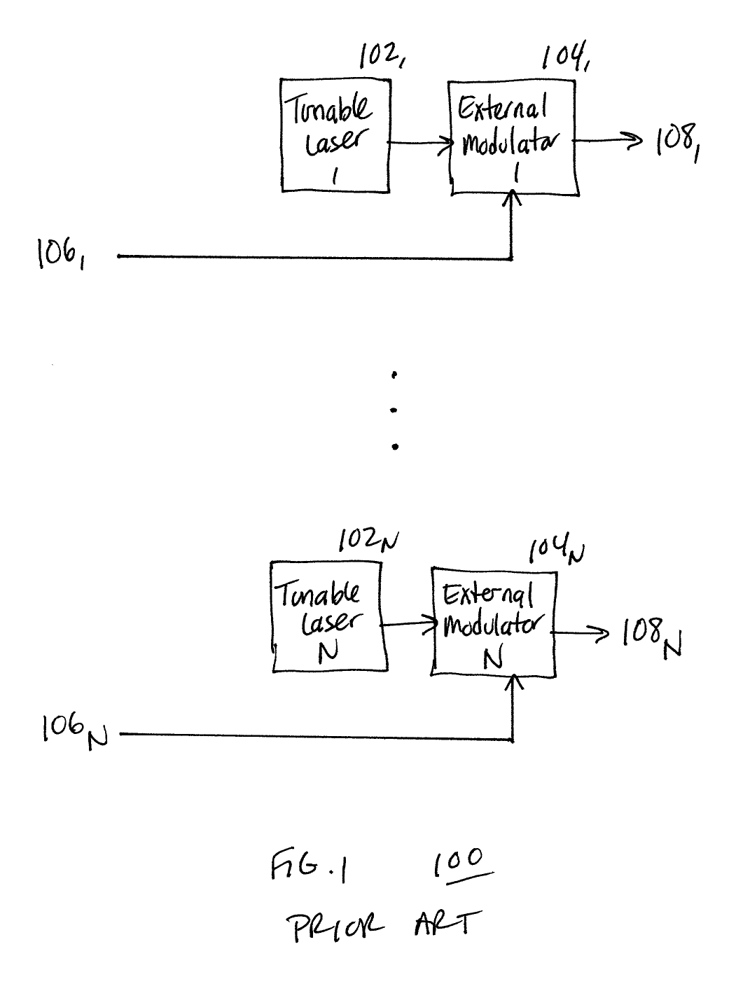

FIG. 1 shows an exemplary optical communication system 100 in which N tunable lasers and N external modulators are used to produce N optical data streams at N specific wavelengths, as is known in the art. The output of each of the N tunable lasers 102₁-120_{N} is coupled to the input of one of the N external modulators 104₁-104_{N}. Each of the N tunable lasers 102₁-120_{N} is tuned to one of the N specific wavelengths, and each of N data sources 106₁-106_{N} is fed into one of the N external modulators 104₁-104_{N}. This produces N optical data streams 108₁-108_{N} at the N specific wavelengths.

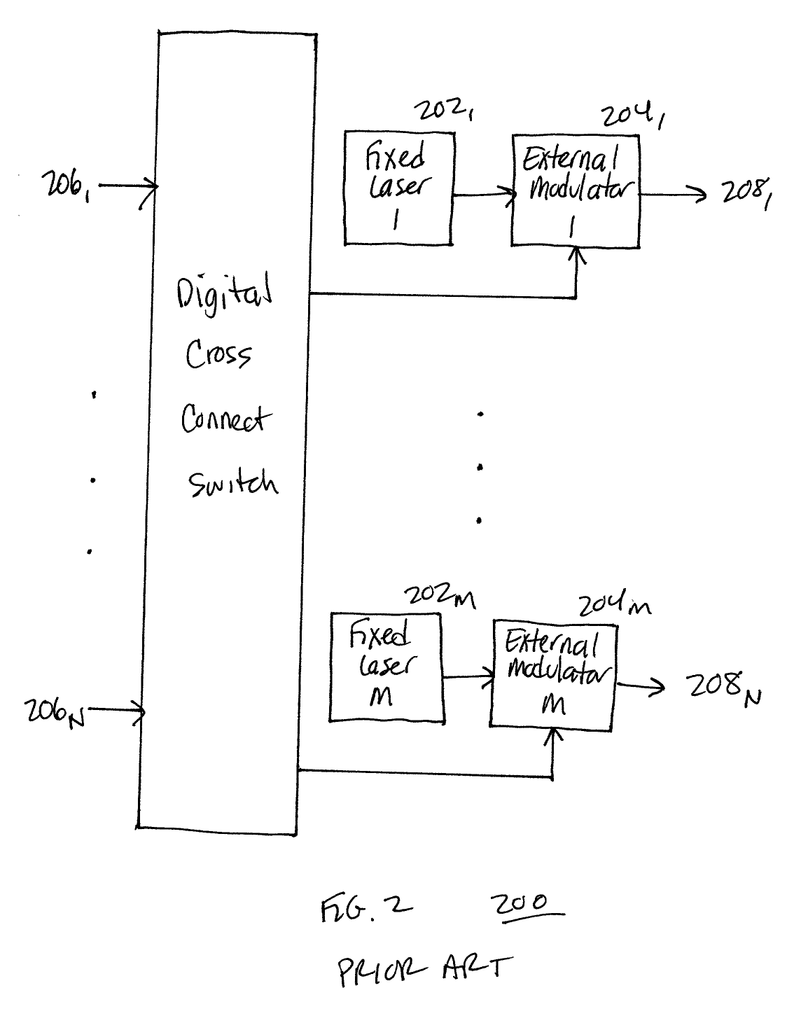

FIG. 2 shows an exemplary optical communication system 200 in which M fixed wavelength lasers and M external modulators are used to produce N optical data streams at N specific wavelengths, as is known in the art. The output of each of the M fixed wavelength lasers 202₁-202_{M} is coupled to the input of one of the M external modulators 204₁-204_{M}. A digital cross-connect switch 210 is coupled between the N data signals 206₁-206_{N} and the M external modulators 204₁-204_{M}. The digital cross-connect switch 210 is capable of routing the N data signals 206₁-206_{N} to any N of the M external modulators 204₁-204_{M}. The digital cross-connect switch 210 is configured to route the N data signals 206₁-206_{N} to those N of the M external modulators 204₁-204_{M} that are associated with those N of the M fixed wavelength lasers 202₁-202_{M} having the N specific wavelengths. This produces N optical data streams 208₁-208_{N} at the N specific wavelengths.

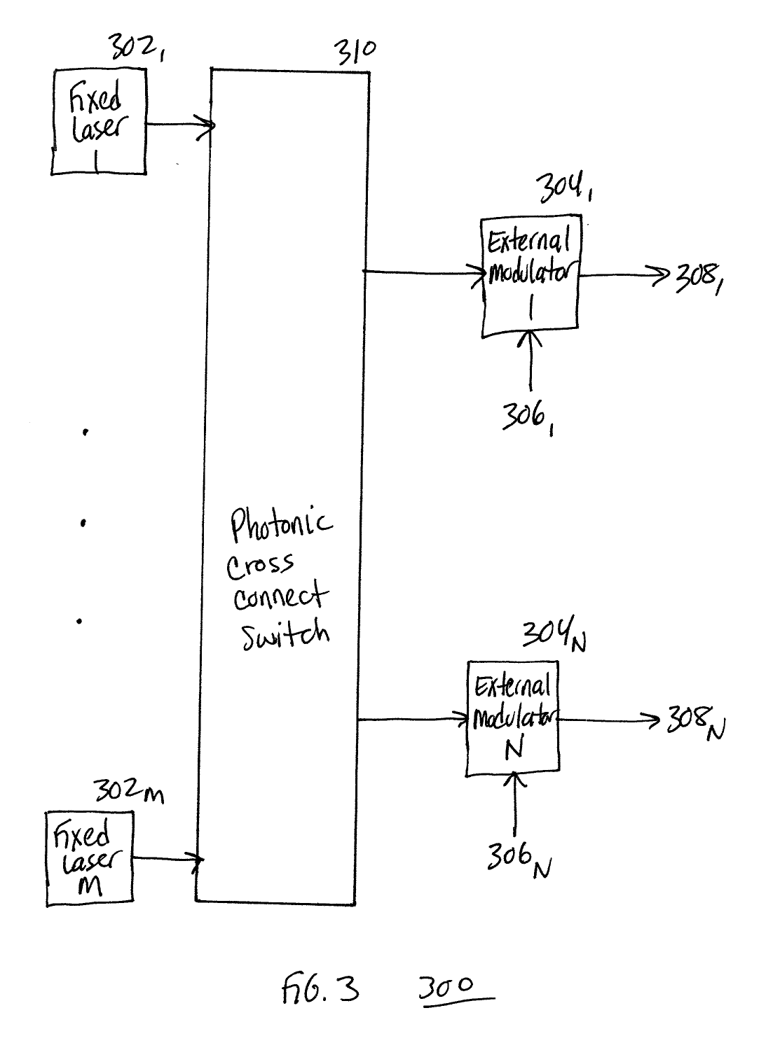

FIG. 3 shows an exemplary optical communication system 300 in which M fixed wavelength lasers and N external modulators are used to produce N optical data streams at N specific wavelengths. The outputs of the M fixed wavelength lasers 302₁-302_{M} are coupled to the optical inputs of the photonic cross-connect switch 310, and the outputs of the photonic cross-connect switch 310 are coupled to the inputs of the N external modulators 304₁-304_{N}. The photonic cross-connect switch 310 is configured to route the outputs of those N of the M fixed wavelength lasers 302₁-302_{M} having the N specific wavelengths to the inputs of the N external modulators 304₁-304_{N}. Each of N data sources 306₁-306_{N} is fed into one of the N external modulators 304₁-304_{N}. This produces N optical data streams 308₁-308_{N} at the N specific wavelengths.

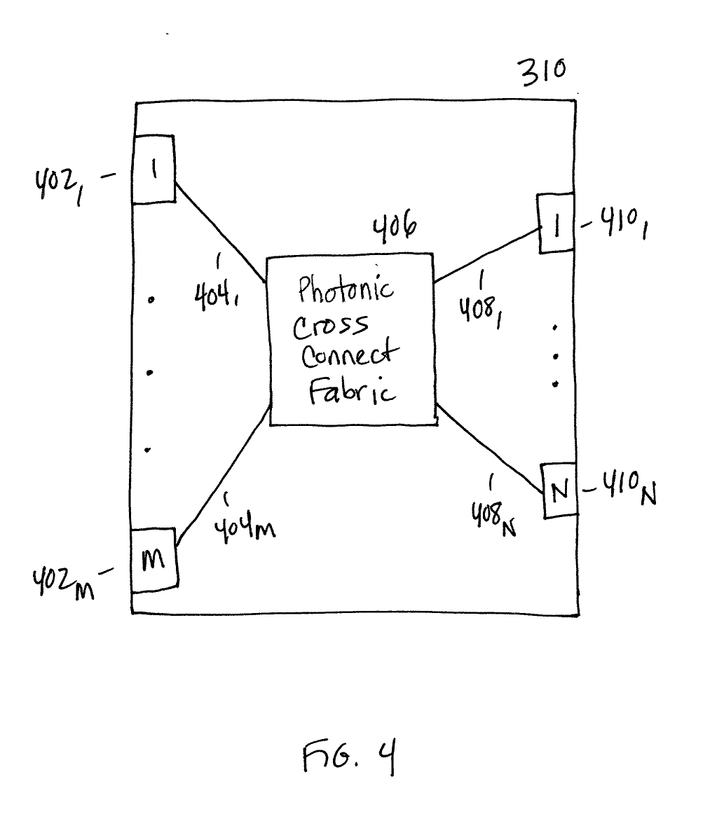

FIG. 4 is a block diagram showing the relevant components of the photonic cross-connect switch 310. Among other things, the photonic cross-connect switch 310 includes at least M optical inputs 402₁-402_{M} that are coupled to a photonic cross-connect fabric 406 via PM fibers 404₁-404_{M}. The photonic cross-connect switch 310 also includes at least N optical outputs 410₁-410_{N} that are coupled to the photonic cross-connect fabric 406 via PM fibers 408₁-408_{N}. The photonic cross-connect fabric 406 is capable of routing any N of the M optical inputs 402₁-402_{M} to the N optical outputs 410₁-410_{N}. The photonic cross-connect switch 310 maintains the polarity of the optical carriers that are switched from the N of the M optical inputs 402₁-402_{M} to the N optical outputs 410₁-410_{N}.

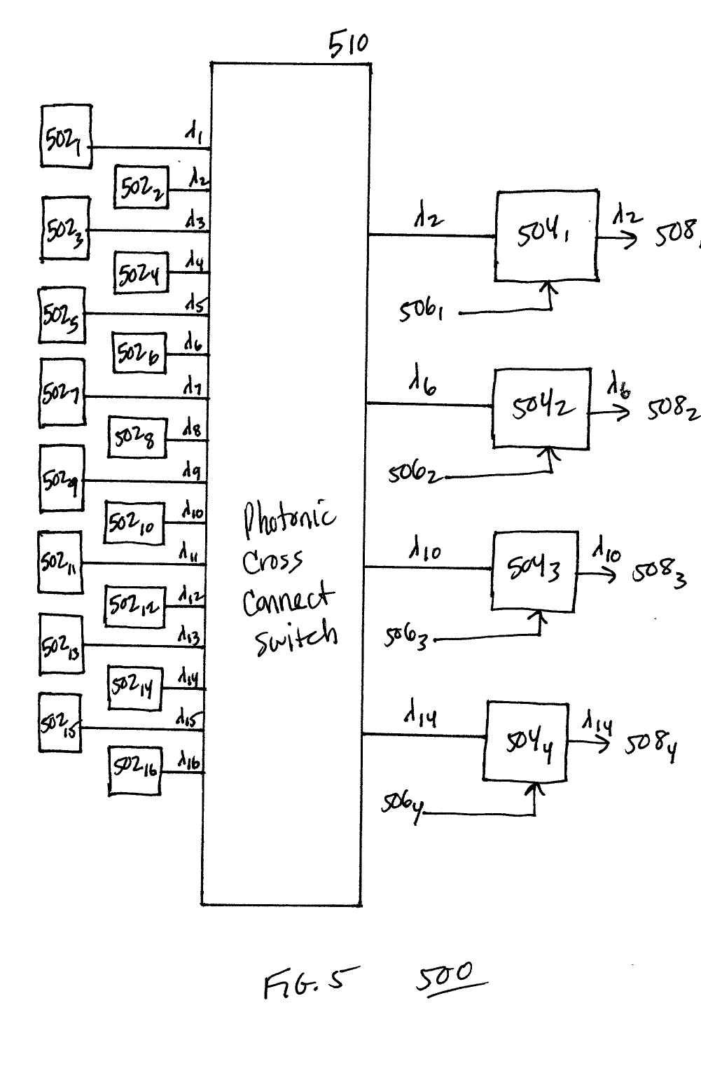

FIG. 5 shows an exemplary optical communication system 500 for producing four optical data streams at any four of sixteen wavelengths. The outputs of sixteen fixed wavelength lasers 502₁-502₁₆, which produce fixed wavelengths λ₁-λ₁₆, respectively, are coupled to the inputs of the photonic cross-connect switch 510. The outputs of the photonic cross-connect switch 510 are coupled to the inputs of four external modulators 504₁-504₄. The photonic cross-connect switch 510 is capable of routing the outputs of any four of the sixteen fixed wavelength lasers 502₁-502₁₆ to the four external modulators 504₁₋₅₀₄₄. In this example, the photonic cross-connect switch 510 is configured to route the output of fixed wavelength laser 502₂ (λ₂) to external modulator 504₁, route the output of fixed wavelength laser 502₆ (λ₆) to external modulator 504₂, route the output of fixed wavelength laser 502₁₀ (λ₁₀) to external modulator 504₃, and route the output of fixed wavelength laser 502₁₄ (λ₁₄) to external modulator 504₄. Data signal 506₁ is fed to external modulator 504₁ to produce optical data stream 508₁ at wavelength λ₂. Data signal 506₂ is fed to external modulator 504₂ to produce optical data stream 508₂ at wavelength λ₆. Data signal 506₃ is fed to external modulator 504₃ to produce optical data stream 508₃ at wavelength λ₁₀. Data signal 506₄ is fed to external modulator 504₄ to produce optical data stream 508₄ at wavelength λ₁₄.

It should be noted the photonic cross-connect switch (310, 510) preferably maintains the polarity of each optical carrier from input to output. In exemplary embodiments of the invention, PM fibers are used to maintain the polarity of optical carriers from input to output within the photonic cross-connect switch. However, alternative techniques for maintaining the polarity of optical carriers from input to output within the photonic cross-connect switch may also be used, and are intended to fall within the scope of the present invention.

The present invention may be embodied in other specific forms without departing from the true scope of the invention. The described embodiments are to be considered in all respects only as illustrative and not restrictive.

What is claimed is:

1. An optical communication system comprising a first number M of fixed wavelength lasers coupled to a second number N of external modulators (N less than M) through a photonic cross-connect switch, wherein the photonic cross-connect switch is capable of routing the optical carriers of any N of the M fixed wavelength lasers to the N external modulators while maintaining the polarity of the N optical carriers routed to the N external modulators, and wherein the N external modulators are coupled to N data signals for producing N optical data streams from the N optical carriers and the N data signals.

2. The optical communication system of claim 1, wherein each of the N data signals is fed to a different one of the N external modulators.

3. The optical communication system of claim 1, wherein the outputs of the fixed wavelength lasers comprises optical carriers at distinct wavelengths.

4. The optical communication system of claim 1, wherein the photonic cross-connect switch comprises:
at least M optical inputs coupled to the outputs of the M fixed wavelength lasers;
at least N optical outputs coupled to the inputs of the N external modulators; and
a photonic cross-connect fabric coupled to the at least M optical inputs and to the at least N optical outputs via polarization maintaining fiber for routing the optical carriers of any N of the M fixed wavelength lasers to the N external modulators.

5. The optical communication system of claim 4, wherein the photonic cross-connect fabric comprises a Micro Electro Mechanical System (MEMS).

6. The optical communication system of claim 4, wherein the photonic cross-connect fabric comprises a Micro Opto Electro Mechanical System (MOEMS).

7. The optical communication system of claim 4, wherein the photonic cross-connect fabric comprises a bubble (champagne) optical switching system.

8. The optical communication system of claim 4, wherein the photonic cross-connect fabric comprises a lithium niobate optical switching system.

9. The optical communication system of claim 4, wherein the photonic cross-connect fabric comprises a liquid crystal optical switching system.

10. A photonic cross-connect device comprising at least M optical inputs coupled to at least N optical outputs (N less than M) through a photonic cross-connect fabric that is coupled to the at least M optical inputs and to the at least N optical outputs via polarization maintaining fiber and is capable of routing optical signals received over any N of M optical inputs to the N optical outputs.

11. The photonic cross-connect device of claim 10, wherein the at least M optical inputs are couplable to at least M fixed wavelength lasers, and wherein the optical signals are optical carriers at distinct wavelengths.

12. The photonic cross-connect device of claim 10, wherein the photonic cross-connect fabric comprises a Micro Electro Mechanical System (MEMS).

13. The photonic cross-connect device of claim 10, wherein the photonic cross-connect fabric comprises a Micro Opto Electro Mechanical System (MOEMS).

14. The photonic cross-connect device of claim 10, wherein the photonic cross-connect fabric comprises a bubble (champagne) optical switching system.

15. The photonic cross-connect device of claim 10, wherein the photonic cross-connect fabric comprises a lithium niobate optical switching system.

16. The photonic cross-connect device of claim 10, wherein the photonic cross-connect fabric comprises a liquid crystal optical switching system.

17. A method for producing optical data streams in an optical communication system, the method comprising:
maintaining a first number M fixed wavelength lasers, each fixed wavelength laser having an output of a different wavelength that the other fixed wavelength lasers;
maintaining a second number N external modulators, wherein the second number N is less than the first number M;
routing optical carriers from each of a predetermined N of the M fixed wavelength lasers to a different one of the N external modulators while maintaining the polarity of the optical carriers; and
feeding a data signal to each of the N external modulators to produce N optical data streams at N specific wavelengths.

18. The method of claim 17, wherein routing the output of each of a predetermined N of the M fixed wavelength lasers to a different one of the N external modulators comprises:
feeding the outputs of the M fixed wavelength lasers into a photonic cross-connect device that is capable of routing the optical carriers of the any N of the M fixed wavelength lasers to the N external modulators; and
configuring the photonic cross-connect device to route the predetermined N of the M fixed wavelength lasers to a different one of the N external modulators.
